(19) United States
(12) Patent Application Publication
(10) Pub. No.: US 2017/0352451 A1
(43) Pub. Date: Dec. 7, 2017

(54) METAL CLAD CABLE HAVING PARALLEL LAID CONDUCTORS

(71) Applicant: AFC Cable Systems, Inc., New Bedford, MA (US)

(72) Inventors: David Campbell, New Bedford, MA (US); George Anthony Straniero, Freehold, NJ (US)

(21) Appl. No.: 15/606,104

(22) Filed: May 26, 2017

Related U.S. Application Data
(60) Provisional application No. 62/345,027, filed on Jun. 3, 2016.

(51) Int. Cl. H01B 7/18; H01B 13/00; H01B 7/02; H01B 13/22; H01B 7/00

(52) U.S. Cl. CPC H01B 7/1805; H01B 13/22; H01B 7/0009; H01B 7/0275; H01B 13/0036

(57) ABSTRACT

A Metal-Clad (MC) cable assembly is provided. In one approach, the MC cable assembly includes a core having a plurality of conductors laid parallel to one another, each of the plurality of conductors including an electrical conductor and insulation, with or without a jacket layer. The MC cable assembly further includes a metal sheath disposed over the core. In some approaches, the MC cable assembly further includes an assembly tape disposed around the plurality of conductors. In some approaches, the MC cable assembly further includes a subassembly having a set of conductors, and an assembly jacket layer disposed over the subassembly. In some approaches, a polymeric protective layer is provided over an insulation layer of one or more of the plurality of conductors and the subassembly. In some approaches, a bonding/grounding conductor may also be cabled with the plurality of conductors.

### CROSS-REFERENCE TO RELATED APPLICATION

This application claims priority to U.S. Provisional Patent Application No. 62/345,027, filed Jun. 3, 2016, entitled “Metal Clad Cable Having Parallel Laid Conductors,” and incorporated by reference herein in its entirety.

### FIELD OF THE DISCLOSURE

The present disclosure relates generally to a Metal-Clad cable type. More particularly, the present disclosure relates to a Metal-Clad cable assembly including parallel laid conductors.

### DISCUSSION OF RELATED ART

Armored cable (“AC”) and Metal-Clad (“MC”) cable provide electrical wiring in various types of construction applications. The type, use and composition of these cables should satisfy certain standards as set forth, for example, in the National Electric Code® (NEC®). (National Electrical Code and NEC are registered trademarks of National Fire Protection Association, Inc.) These cables house electrical conductors within a metal armor. The metal armor may be flexible to enable the cable to bend while still protecting the conductors against external damage during and after installation. The armor housing the electrical conductors may be made from steel or aluminum, copper-alloys, bronze-alloys and/or aluminum alloys. Typically, the metal armor sheath is formed from strip steel, for example, which is helically wrapped to form a series of interlocked sections along a longitudinal length of the cable. Alternatively, the sheaths may be made from smooth or corrugated metal.

Generally, AC and MC cables have different internal constructions and performance characteristics and are governed by different standards. For example, AC cable is manufactured to UL Standard 4 and can contain up to four (4) insulated conductors individually wrapped in a fibrous material which are cabled together in a left hand lay. Each electrical conductor is covered with a thermoplastic insulation and a jacket layer. The conductors are disposed within a metal armor or sheath. If a grounding conductor is employed, the grounding conductor is either (i) separately covered or wrapped with the fibrous material before being cabled with the thermoplastic insulated conductors; or (ii) enclosed in the fibrous material together with the insulated conductors for thermoplastic insulated conductors. Additionally, in AC type cable, a bonding strip or wire may be laid lengthwise longitudinally along the cabled conductors, and the assembly is fed into an armoring machine process. The bonding strip is in intimate contact with the metal armor or sheath providing a low-impedance fault return path to safely conduct fault current. The bonding wire is unique to AC cable and allows the outer metal armor in conjunction with the bonding strip to provide a low impedance equipment grounding path.

In contrast, MC cable is manufactured according to UL standard 1569 and includes a conductor assembly with almost no limit on the number of electrical conductors. The conductor assembly may contain a grounding conductor. The electrical conductors and the ground conductor are cabled together in a left or right hand lay and encased collectively in an overall covering. Similar to AC cable, the assembly may then be fed into an armoring machine where metal tape is helically applied around the assembly to form a metal sheath. The metallic sheath of continuous or corrugated type MC cable may be used as an equipment grounding conductor if the ohmic resistance satisfies the requirements of UL 1569. A grounding conductor may be included which, in combination with the metallic sheath, would satisfy the UL ohmic resistance requirement. In this case, the metallic sheath and the grounding/bonding conductor would comprise what is referred to as a metallic sheath assembly.

### SUMMARY OF THE DISCLOSURE

One embodiment of the disclosure may include a metal clad (MC) cable assembly, including a core including a plurality of conductors laid parallel to one another, each of the plurality of conductors including an electrical conductor, insulation with or without a jacket layer, and a metal sheath disposed over the core.

Another embodiment of the disclosure may include a method of making a metal clad cable assembly, the method including providing a core including a plurality of parallel laid conductors, each of the plurality of conductors including an electrical conductor and insulation, with or without a jacket layer. The method further includes disposing a metal sheath over the core.

Yet another embodiment of the disclosure may include a metal clad (MC) cable assembly including a plurality of conductors laid substantially parallel to one another, each of the plurality of conductors including an electrical conductor, an insulation layer provided directly atop the electrical conductor, and a jacket layer provided directly atop the insulation layer. The MC cable assembly may further include a metal sheath disposed over the plurality of conductors, a subassembly including a set of conductors, and an assembly jacket layer disposed over the subassembly.

### BRIEF DESCRIPTION OF THE DRAWINGS

The accompanying drawings illustrate approaches of the disclosed metal clad cable assembly so far devised for the practical application of the principles thereof, and in which:

FIGS. 1A-B are side views of various MC cable assemblies according to approaches of the disclosure;

FIG. 2 is a cross-sectional view of the MC cable assembly of FIG. 1A according to an example approach of the disclosure;

FIG. 3 is a cross-sectional view of the MC cable assembly of FIG. 1B according to an example approach of the disclosure;

FIG. 4A is a detail cross-sectional view of an individual conductor of the MC cable assembly of FIGS. 1-3 according to approaches of the disclosure;

FIG. 4B is a detail cross-sectional view of an individual conductor of the MC cable assembly of FIGS. 1-3 according to another approach of the disclosure;

FIG. 4C is a detail cross-sectional view of an individual conductor of the MC cable assembly of FIGS. 1-3 according to another approach of the disclosure;

FIG. 5 is a cross-sectional view of a MC cable assembly in accordance approaches of the present disclosure;

FIG. 6 is a cross-sectional view of a MC cable assembly in accordance approaches of the present disclosure;

FIG. 7 is a cross-sectional view of a MC cable assembly in accordance approaches of the present disclosure;

FIG. 8 is a cross-sectional view of a MC cable assembly in accordance approaches of the present disclosure;

FIG. 9 is a cross-sectional view of a MC cable assembly in accordance approaches of the present disclosure;

FIG. 10 is a cross-sectional view of a MC cable assembly in accordance approaches of the present disclosure;

FIG. 11 is a cross-sectional view of a MC cable assembly in accordance approaches of the present disclosure;

FIG. 12 is a cross-sectional view of a MC cable assembly in accordance approaches of the present disclosure;

FIG. 13 is a cross-sectional view of a MC cable assembly in accordance approaches of the present disclosure;

FIG. 14 is a cross-sectional view of a MC cable assembly in accordance approaches of the present disclosure; and

FIG. 15 is a flow chart illustrating an example method of making an MC cable assembly according to the disclosure.

The drawings are not necessarily to scale. The drawings are merely representations, not intended to portray specific parameters of the disclosure. Furthermore, the drawings are intended to depict example embodiments of the disclosure, and therefore is not considered as limiting in scope.

Furthermore, certain elements in some of the figures may be omitted, or illustrated not-to-scale, for illustrative clarity. The cross-sectional views may be in the form of “slices”, or “near-sighted” cross-sectional views, omitting certain background lines otherwise visible in a “true” cross-sectional view, for illustrative clarity. Furthermore, for clarity, some reference numbers may be omitted in certain drawings.

### DESCRIPTION OF EMBODIMENTS

The present disclosure will now proceed with reference to the accompanying drawings, in which various approaches are shown. It will be appreciated, however, that the disclosed MC cable assembly may be embodied in many different forms and should not be construed as limited to the approaches set forth herein. Rather, these approaches are provided so that this disclosure will be thorough and complete, and will fully convey the scope of the disclosure to those skilled in the art. In the drawings, like numbers refer to like elements throughout.

As used herein, an element or operation recited in the singular and proceeded with the word “a” or “an” should be understood as not excluding plural elements or operations, unless such exclusion is explicitly recited. Furthermore, references to “one approach” or “one embodiment” of the present disclosure are not intended to be interpreted as excluding the existence of additional approaches or embodiments that also incorporate the recited features.

For the sake of convenience and clarity, terms such as “top,” “bottom,” “upper,” “lower,” “vertical,” “horizontal,” “lateral,” and “longitudinal” will be used herein to describe the relative placement and orientation of these components and their constituent parts with respect to the geometry and orientation of a component of a device as appearing in the figures. The terminology will include the words specifically mentioned, derivatives thereof, and words of similar meaning and/or significance.

As stated above, approaches provided herein are directed to a Metal-Clad (MC) cable assembly. In one approach, the MC cable assembly includes a core having a plurality of conductors laid parallel to one another, each of the plurality of conductors including an electrical conductor, insulation and an optional jacket layer. The MC cable assembly further includes a metal sheath disposed over the core and the bonding/grounding conductor. In some approaches, the MC cable assembly further includes an assembly tape disposed around the plurality of conductors. In some approaches, the MC cable assembly further includes a subassembly having a set of conductors, and an assembly jacket layer disposed over the subassembly. In some approaches, a polymeric protective layer is provided over the insulation layer of one or more of the plurality of conductors and the subassembly. In some approaches, a bonding/grounding conductor may also be cabled with the plurality of conductors or laid straight.

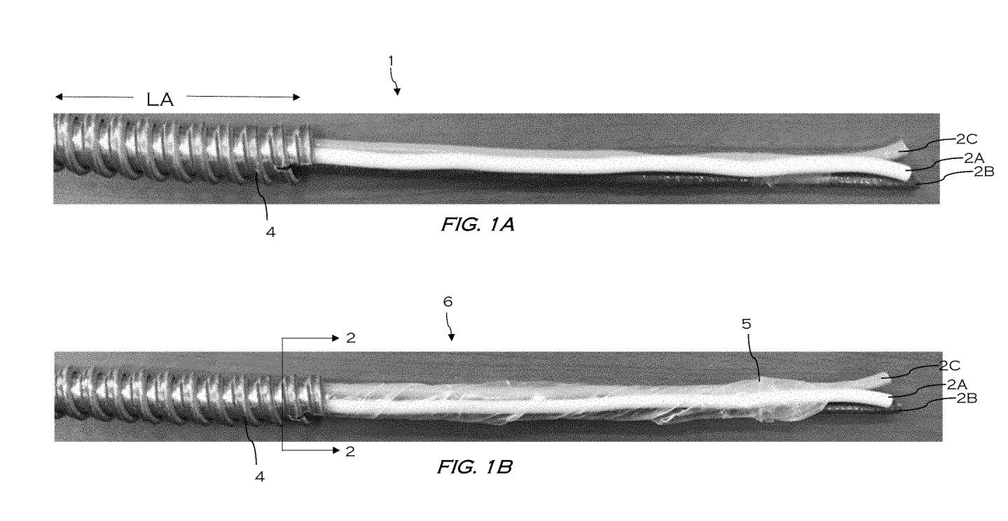

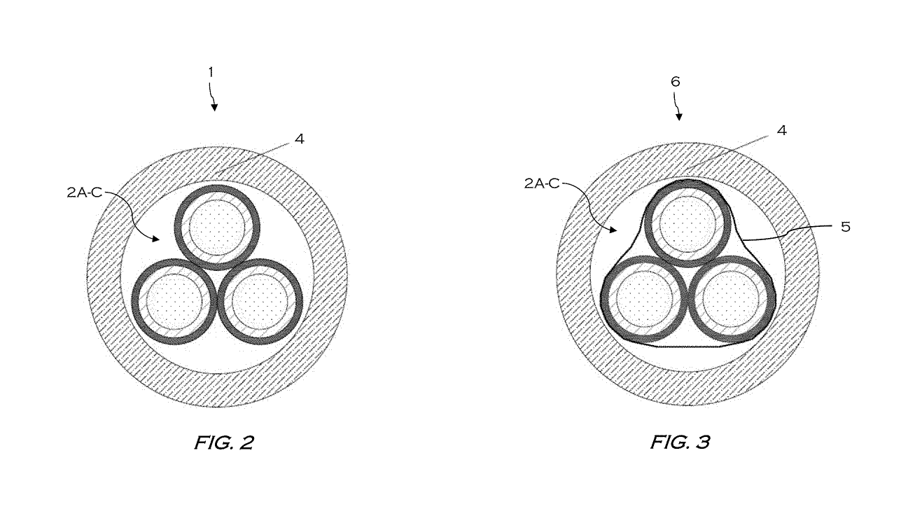

Referring now to FIGS. 1-3, example MC cable assemblies according to various approaches will be described in greater detail. As shown in the side view of FIG. 1A and cross sectional view of FIG. 2, an MC cable assembly 1 includes a plurality of conductors 2A-C (e.g., power conductors) disposed within a metal sheath 4. Unlike prior art approaches, each of the plurality of conductors 2A-C are laid in parallel with one another along a length of the cable assembly 1, for example, so that the longitudinal axis of each conductor 2A-C runs parallel to a longitudinal axis ‘LA’ of metal sheath 4.

It will be appreciated that the plurality of conductors 2A-C may be laid parallel, or substantially parallel, with one another along a length of the cable assembly 1. In some embodiments, to be considered parallel or substantially parallel, the plurality of conductors 2A-C can include a small number of twists along the length of the cable assembly 1. In one example, the plurality of parallel laid conductors 2A-C may have less than three (3) twists along the length of the cable assembly 1. In another example, the plurality of parallel laid conductors 2A-C may have one (1) twist along the length of the cable assembly 1. Stated another way, in some examples, the plurality of parallel laid conductors 2A-C may have between 0.1-0.25 twists/ft.

As shown in the side view of FIG. 1B and cross sectional view of FIG. 3, an MC cable assembly 6 may further include an assembly tape 5 surrounding the plurality of conductors 2A-C disposed within the metal sheath 4. As shown, the plurality of conductors 2A-C are laid parallel to one another along a length of the cable assembly 1. The assembly tape 5 may extend along the length of the MC cable assembly 6, and may be provided as an alternative to a protective polypropylene layer. In various embodiments, the assembly tape 5 may be helically wrapped or longitudinally wrapped around the plurality of conductors 2A-C.

In various approaches, the plurality of conductors 2A-C of the cable assembly 1 may each be, for example, solid conductors having a size between 28 American Wire Gauge (AWG) and 6 AWG, or may each be, for example, solid and/or stranded electrical conductors having a size between 18 AWG and 6 AWG. In some approaches, the plurality of conductors 2A-C include first, second and third power conductors (e.g., 120V or 277V), wherein each of the conductors 2A-C can have a size between 18 AWG and 2000 KCM.

In example embodiments, the metal sheath 4 may be formed as a seamless or welded continuous sheath, and has a generally circular cross section with a thickness of about 0.005 to about 0.060 inches. Alternatively, metal sheath 4 may be formed from flat or shaped metal strip, the edges of which are helically wrapped and interlock to form a series of convolutions along the length of the MC cable assembly 1. In this manner, metal sheath 4 allows the resulting MC cable assembly 1 to have a desired bend radius sufficient for installation within a building or structure. The sheath 4 may also be formed into shapes other than generally circular such as, for example, rectangles, polygons, ovals and the like. Metal sheath 4 provides a protective metal covering around the plurality of conductors 2A-C.

Although not shown, it will be appreciated that MC cable assembly 1 and MC cable assembly 6 of FIGS. 1A-B, respectively, may include one or more filler members within metal sheath 4. In one approach, a longitudinally oriented filler member is disposed within metal sheath 4 adjacent to one or more of the plurality of conductors 2A-C to press the conductors 2A-C radially outward into contact with the inside surface of metal sheath 4. The filler member can be made from any of a variety of fiber or polymer materials. Furthermore, the filler member can be used with MC cable assemblies having any number of insulated conductor assemblies.

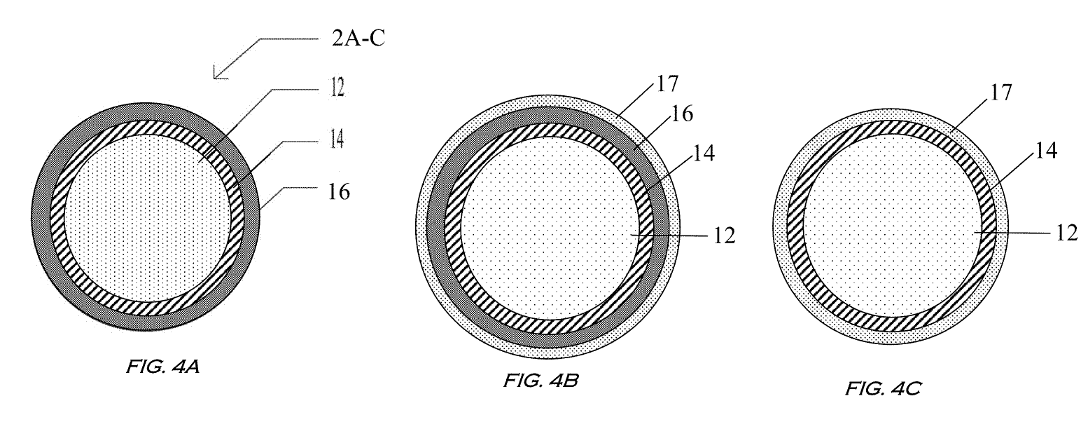

Referring now to the side views of FIGS. 1A-B and cross-sectional view of FIG. 4A, an example conductor of the MC cable assembly 1 will be described in greater detail. As shown, each of the plurality of conductors 2A-C can each include a stranded or solid electrical conductor 12 having a concentric insulation layer(s) 14, and a jacket layer 16 disposed on/over the insulation layer 14. In some approaches, the concentric insulation layer 14 and the jacket layer 16 are extruded over each of the individual electrical conductors 12 of the plurality of conductors 2A-C. In other embodiments, as will be described below, the jacket layer 16 is not provided.

The electrical conductor 12, insulation layer 14 and jacket layer 16 may define an NEC® Type thermoplastic fixture wire nylon (TFN), thermoplastic flexible fixture wire nylon (TFFN), thermoplastic high heat resistant nylon (THHN), thermoplastic heat and water resistant nylon (THWN) or THWN-2 insulated conductor. In other approaches, the conductors 2A-C may define an NEC® Type thermoplastic heat and water resistant (THW), thermoplastic high heat and water resistant (THHW), cross-linked polyethylene high heat-resistant water-resistant (XHHW) or XHHW-2 insulated conductor. In one example approach, the insulation layer 14 is polyvinylchloride (PVC) and has a thickness of approximately 15-125 mil. In one approach, jacket layer 16 is nylon and has a thickness of approximately 4-9 mil.

In some embodiments, one or more conductors of the MC cable assembly 1 may include a fibrous covering (e.g., a paper layer). For example, as shown in FIG. 4B, a fibrous covering 17 is disposed over/atop the jacket layer 16. The fibrous covering 17 may be wrapped helically or longitudinally along the conductor 2A-C. In other embodiments, for example as shown in FIG. 4C, the fibrous covering is disposed directly over the insulation layer 14.

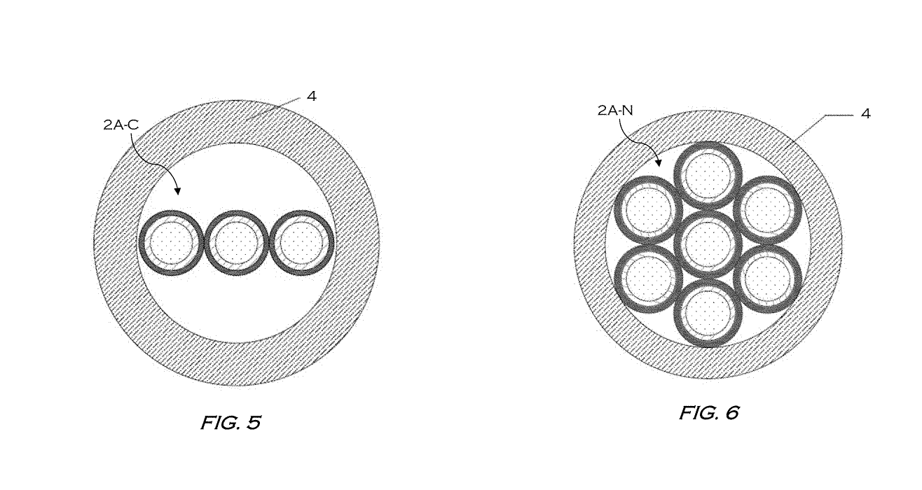

Referring now to the cross-sectional view of FIG. 5, one possible arrangement of the plurality of conductors 2A-C is shown. In this embodiment, the plurality of conductors 2A-C are arranged side by side along a plane (e.g., a horizontal plane). It will be appreciated, however, that this arrangement is non-limiting. Additionally, it will be appreciated that the number of conductors is not limited to three (3), for example as depicted in FIGS. 1-3 and 5. Instead, as shown in FIG. 6, the MC cable assembly may include a plurality of conductors 2A-N, which substantially fill an interior of the metal sheath 4.

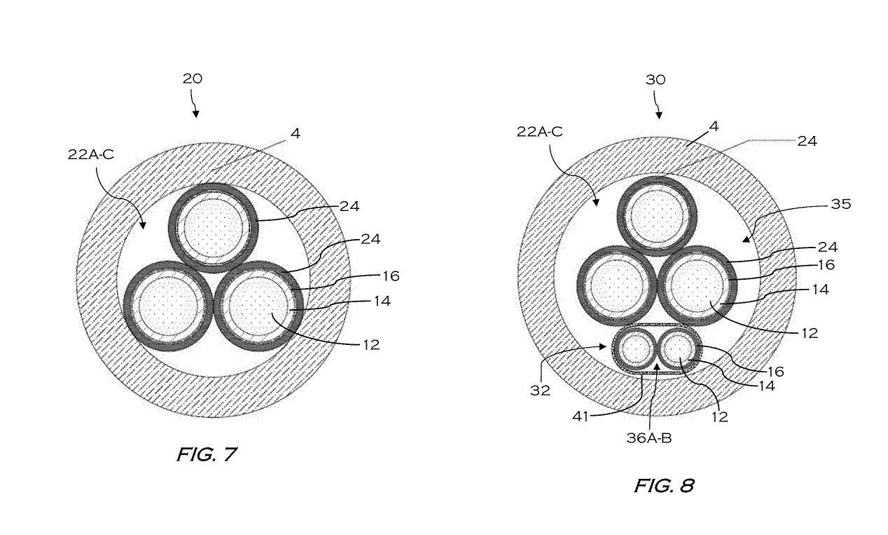

Referring now to the cross-sectional view of FIG. 7, an MC cable assembly 20 according to another approach will be described in greater detail. As shown, the MC cable assembly 20 can include any or all of the features of the MC cable assembly 1 or MC cable assembly 6 shown respectively in FIGS. 1-4, including one or more conductors having the features previously described above. In this embodiment, the MC cable assembly 20 may additionally include a protective covering 24 for each of the plurality of conductors 22A-C. More specifically, the protective covering 24 is disposed over an exterior surface of the jacket layer 16 of each of the plurality of conductors 2A-C.

The protective covering 24 may be a polymeric protective layer such as polypropylene. Furthermore, the protective covering 24 may have a thickness between 2-15 mils and may be disposed over the plurality of conductors 22A-C and, more particularly, may be extruded over the plurality of conductors 22A-C. Although the protective covering 24 has been disclosed as being polypropylene, in some approaches it can be made from other materials such as, but not limited to, polyethylene, polyester, etc. The protective covering 24 can provide mechanical strength to resist buckling, crushing and scuffing of the conductors 22A-C.

Referring now to the cross-sectional view of FIG. 8, an MC cable assembly 30 according to another approach of the disclosure will be described in greater detail. As shown, the MC cable assembly 30 can include any or all of the features of the MC cable assembly 20 shown in FIG. 7 including the conductors 22A-C each having the features previously described. As shown, the MC cable assembly 30 has a cable subassembly 32 cabled with the conductors 22A-C to form a core 35. The cable subassembly 32 and the conductors 22A-C may be cabled together in either a right or left hand lay or laid parallel. Core 35 can be enclosed by a metal sheath 4. As shown, cable subassembly 32 includes a first conductor 36A and a second conductor 36B cabled together to form a twisted pair conductor subassembly, which is disposed within an assembly jacket layer 41. In an example approach, cable subassembly 32 comprises wiring principally for Class 2 and Class 3 circuits, as described in Article 725 of the NEC®. Although only a single pair of conductors 36A-B is shown in subassembly 32, it will be appreciated that subassembly 32 may have additional pairs (e.g., 4 wires ranging from 28-12 AWG). Alternately, in another approach, a plurality (i.e., more than one) of subassemblies 32 can be included within core 35, each of the plurality of subassemblies 32 being arranged in parallel with one another and with the conductors 22A-C.

The first and second conductors 36A-B of subassembly 32 may each be, for example, 16 American Wire Gauge (AWG) solid conductors, while the plurality of conductors 22A-C may each be, for example, 12 AWG solid and/or stranded electrical conductors. In some embodiments, the plurality of conductors 22A-C includes first, second, and third power conductors (e.g., 120V or 277V). In an example approach, each of the conductors 36A-B can have a size between 28 AWG and 6 AWG such that conductors 36A-B are configured to conduct a voltage between zero (0) and approximately 300 Volts. In some approaches, each of the plurality of conductors 22A-C can have a size between 18 AWG and 2000 KCM.

As shown, the first and second conductors 36A-B can each include a stranded or solid electrical conductor 12 having a concentric insulation layer(s) 14, and a jacket layer 16 disposed on the insulation layer 14. In some approaches, the concentric insulation layer 14 and the jacket layer 16 are extruded over each of the individual electrical conductors 12 of the first and second conductors 36A-B of the subassembly 32.

Furthermore, the subassembly 32 is disposed within the assembly jacket layer 41, which extends along the length of the subassembly 32 and is located within metal sheath 4 in an area adjacent the plurality of conductors 22A-C. In approaches, the assembly jacket layer 41 is PVC and has a thickness in the range of 5-80 mils. In one non-limiting example approach, assembly jacket layer 41 has a thickness of approximately 15-30 mils. However, it will be appreciated that the thickness of assembly jacket layer 41 can vary depending on the diameter of the conductor(s) it surrounds. For example, larger diameter conductors generally translate to a thicker jacket layer.

As stated above, the subassembly 32 may be cabled, in a right or left handed lay, with the plurality of conductors 22A-C, which are parallel laid with respect to each other, to form the core 35. Alternatively, the subassembly 32 may extend longitudinally along the metal sheath 4 such that the longitudinal axis of each conductor 36A-B of the subassembly 32 runs parallel to a longitudinal axis of metal sheath 4.

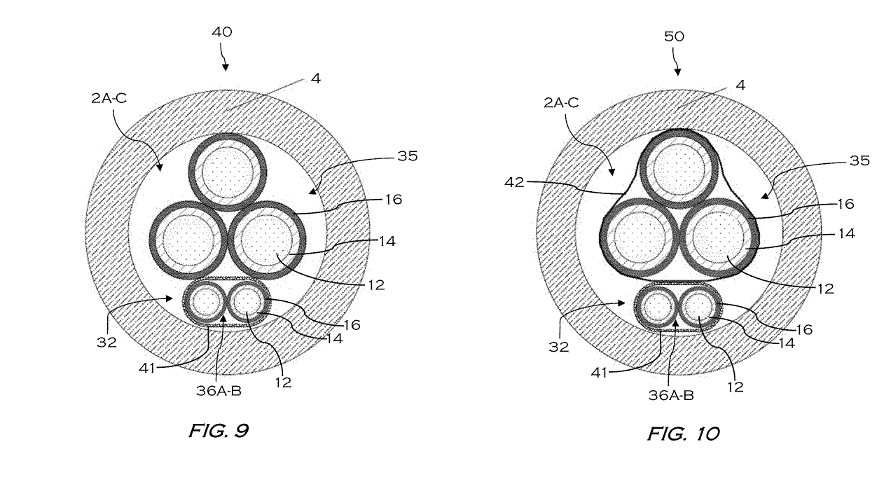

Referring now to the cross-sectional view of FIG. 9, an MC cable assembly 40 according to another approach will be described in greater detail. As shown, the MC cable assembly 40 can include a majority of features of the MC cable assembly 30 shown in FIG. 8. As such, just certain aspects of the MC cable assembly 40 will hereinafter be described for the sake of brevity. In this embodiment, no protective covering (element 24 in FIG. 8) is present for each of the plurality of conductors 2A-C. Instead, each of the plurality of conductors 2A-C includes a stranded or solid electrical conductor 12 having a concentric insulation layer(s) 14, and a jacket layer 16 disposed on/over the insulation layer 14.

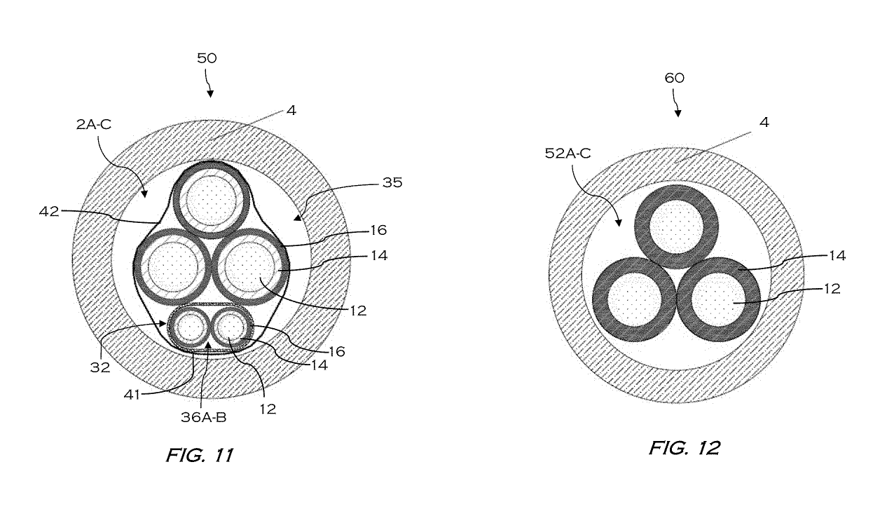

Referring now to the cross-sectional view of FIGS. 10-11, an MC cable assembly 50 according to another approach will be described in greater detail. As shown, the MC cable assembly 50 can include many or all of the features of the MC cable assembly 40 shown in FIG. 9. As such, just certain aspects of the MC cable assembly 50 will hereinafter be described for the sake of brevity. In the embodiment shown in FIG. 10, an assembly tape 42 may be disposed around the plurality of conductors 2A-C. Alternatively, as shown in FIG. 11, the assembly tape 42 may be disposed around the cabled core 35 (e.g., the plurality of conductors 2A-C and the subassembly 32).

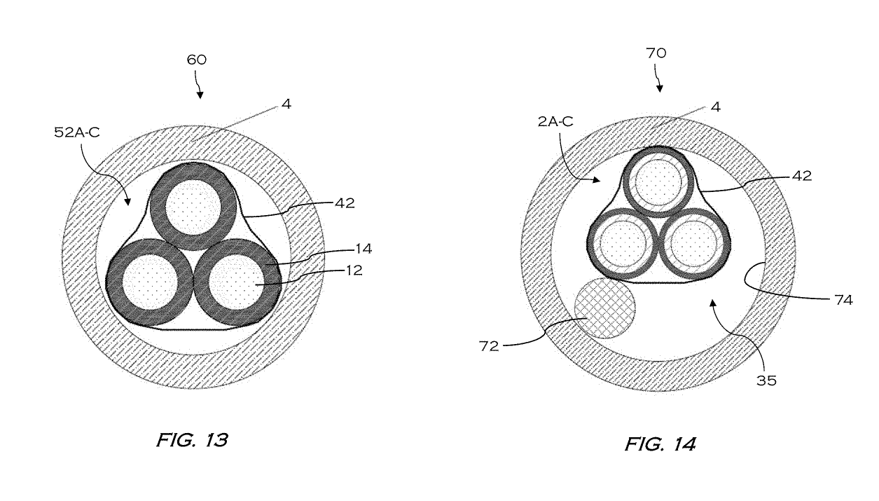

Referring now to the cross-sectional view of FIGS. 12-13, an MC cable assembly 60 according to another approach of the disclosure will be described in greater detail. As shown in FIG. 12, the MC cable assembly 60 can include features similar to that of the MC cable assembly 1 shown in FIG. 2. As such, just certain aspects of the MC cable assembly 60 will hereinafter be described for the sake of brevity. In this embodiment, no jacket layer (element 16 in FIG. 4) is disposed over the electrical conductor 12 of the plurality of conductors 52A-C. Instead, only the insulation layer 14 is formed directly atop the electrical conductor 12. In addition, as shown in FIG. 13, an assembly tape 42 may be disposed around the plurality of conductors 52A-C in an alternative embodiment. The assembly tape 42 may be disposed along an entire length of the MC cable assembly 60.

Referring now to the cross-sectional view of FIG. 14, an MC cable assembly 70 according to another approach will be described in greater detail. As shown in FIG. 14, the MC cable assembly 70 can include features similar to those of the MC cable assembly 6 shown in FIG. 3. As such, just certain aspects of the MC cable assembly 70 will hereinafter be described for the sake of brevity. In this embodiment, the MC cable assembly 70 can further include a bonding/grounding conductor 72 disposed within metal sheath 4. In an example approach, bonding/grounding conductor 72 is a 10 AWG bare aluminum bonding/grounding conductor. The conductors 2A-C of the core 35 may be cabled with the bonding/grounding conductor 72, for example, in either a right hand lay or a left hand lay. Alternatively, bonding/grounding conductor 72 may be disposed adjacent the conductors 2A-C along the metal sheath 4 such that the longitudinal axis of bonding/grounding conductor 72 runs parallel (as opposed to cabled) to a longitudinal axis of the conductors 2A-C and the metal sheath 4. As further shown, the assembly tape 42 may be disposed around the plurality of conductors 2A-C, for example, along an entire length of the MC cable assembly 70.

As shown, the bonding/grounding conductor 72 may be in direct contact with an inner surface 74 of the metal sheath 4 and may act in combination with the sheath 4 to define a metal sheath assembly having an ohmic resistance value about equal to or lower than the ohmic resistance requirements necessary to qualify as an equipment grounding conductor. Alternatively, the bonding/grounding conductor 72 may itself have sufficient ohmic resistance to qualify as an equipment grounding conductor.

In some embodiments, the bonding/grounding conductor 72 may have undulations (alternating crests and troughs) applied as part of an in-line process of forming an MC cable. Alternatively, the undulations can be imparted to the bonding/grounding conductor 72 in a separate off-line process and then brought “pre-formed” to the cabling/twisting process used to form the MC cable.

The bonding/grounding conductor 72 may be made from any of a variety of materials, including aluminum, copper, copper clad aluminum, tinned copper and the like. In one non-limiting example approach, the bonding/grounding conductor 72 is aluminum. It will be appreciated that a bonding/grounding conductor may be similarly included with any of the MC cable assemblies described herein, including MC cable assembly 1, MC cable assembly 6, MC cable assembly 10, MC cable assembly 20, MC cable assembly 30, MC cable assembly 40, MC cable assembly 50, and MC cable assembly 60.

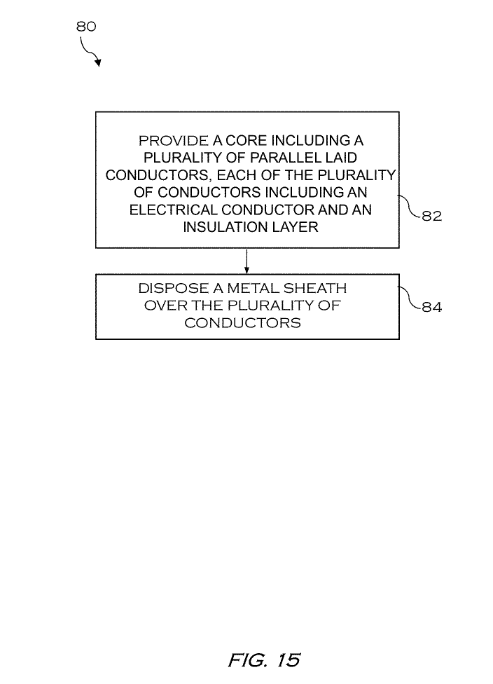

Referring now to FIG. 15, a method 80 of making an MC cable assembly will be described in greater detail. Method 80 includes providing a core including a plurality of parallel laid conductors, each of the plurality of conductors including an electrical conductor and an insulation layer, as shown in block 82. In some approaches, a jacket layer is formed over the electrical conductor. In some approaches, a protective layer is formed (e.g., extruded) over the insulation layer or the jacket layer of one or more of the plurality of conductors. In some embodiments, the core includes a subassembly. In some approaches, the subassembly comprises a cabled set of conductors operating as class 2 or class 3 circuit conductors that are cabled together in a right or left hand lay. In some approaches the plurality of conductors includes first, second and third power conductors (e.g., 120V or 277V). In some approaches, the layer of insulation and the jacket layer are extruded over each of the individual electrical conductors of the plurality of conductors and the subassembly. Method 80 can further include disposing a metal sheath over the core, as shown in block 84.

As will be appreciated, the various approaches described herein for providing parallel laid conductors provide a variety of advantages/improvements including, but not limited to, reducing cable installation time and cost, and reducing materials, while providing mechanical protection for all conductors within the cable.

While the present disclosure has been described with reference to certain approaches, numerous modifications, alterations and changes to the described approaches are possible without departing from the sphere and scope of the present disclosure, as defined in the appended claims. Accordingly, it is intended that the present disclosure not be limited to the described approaches, but that it has the full scope defined by the language of the following claims, and equivalents thereof. While the disclosure has been described with reference to certain approaches, numerous modifications, alterations and changes to the described approaches are possible without departing from the spirit and scope of the disclosure, as defined in the appended claims. Accordingly, it is intended that the present disclosure not be limited to the described approaches, but that it has the full scope defined by the language of the following claims, and equivalents thereof.

What is claimed is:

1. A metal clad (MC) cable assembly, comprising:
a core including a plurality of conductors laid substantially parallel to one another, each of the plurality of conductors including an electrical conductor and an insulation layer; and
a metal sheath disposed over the core.

2. The MC cable assembly of claim 1, further comprising an assembly tape disposed around the plurality of conductors.

3. The MC cable assembly of claim 1, each of the plurality of conductors further including a jacket layer.

4. The MC cable assembly of claim 1, further comprising a fibrous covering disposed over the insulation layer.

5. The MC cable assembly of claim 1, further comprising:
a subassembly including a set of conductors; and
an assembly jacket layer disposed over the subassembly.

6. The MC cable assembly of claim 5, wherein the plurality of conductors and the subassembly are laid substantially parallel with one another.

7. The MC cable assembly of claim 3, further comprising a polymeric protective layer disposed over the jacket layer.

8. The MC cable assembly of claim 1, further comprising a bonding/grounding conductor cabled with the plurality of conductors.

9. The MC cable assembly of claim 3, further comprising a fibrous covering disposed over the jacket layer.

10. The MC cable assembly of claim 1, further comprising a bonding/grounding conductor laid parallel with the plurality of conductors.

11. A method of making a metal clad cable assembly, comprising:
providing a core including a plurality of conductors laid substantially parallel to one another, each of the plurality of conductors including an electrical conductor and an insulation layer; and
disposing a metal sheath over the core.

12. The method of claim 11, further comprising providing a jacket layer over the insulation layer.

13. The method of claim 11, further comprising:
cabling the plurality of conductors together with a subassembly, the subassembly including a set of conductors; and
providing an assembly jacket layer over the subassembly.

14. The method of claim 13, further comprising cabling together the set of conductors of the subassembly, the set of conductors each configured to operate as class 2 or class 3 circuit conductors in accordance with Article 725 of the National Electrical Code®.

15. The method of claim 11, further comprising disposing a fibrous covering over the insulation layer.

16. The method of claim 12, further comprising disposing a polymeric protective layer over the jacket layer.

17. The method of claim 11, further comprising disposing an assembly tape around the plurality of conductors.

18. The method of claim 13, further comprising providing an assembly tape around the plurality of conductors and the subassembly.

19. The method of claim 15, further comprising providing a bonding/grounding conductor within the metal sheath, wherein the bonding/grounding conductor is one of: cabled with the plurality of conductors, or laid parallel with the plurality of conductors.

20. The method of claim 11, further comprising disposing a fibrous covering over the insulation layer.

21. A metal clad (MC) cable assembly, comprising:
a plurality of conductors laid substantially parallel to one another, each of the plurality of conductors including an electrical conductor, an insulation layer provided directly atop the electrical conductor, and a jacket layer provided directly atop the insulation layer;
a metal sheath disposed over the plurality of conductors;
a subassembly including a set of conductors; and
an assembly jacket layer disposed over the subassembly.
